(19) United States
(12) Patent Application Publication
(10) Pub. No.: US 2026/0016567 A1
(43) Pub. Date: Jan. 15, 2026

(54) Materials and Anomalies Identification Methods and Systems Using Millimeter Wavelengths

(71) Applicant: The Government of the United States of America, as represented by the Secretary of Homeland Security, Washington, DC (US)

(72) Inventors: James Weatherall, Linwood, NJ (US); Jeffrey Barber, Vineland, NJ (US)

(73) Assignee: The Government of the United States of America, as represented by the Secretary of Homeland Security, Washington, DC (US)

(21) Appl. No.: 19/268,567

(22) Filed: Jul. 14, 2025

Related U.S. Application Data
(60) Provisional application No. 63/671,438, filed on Jul. 15, 2024.

(51) Int. Cl. G01S 7/41; G01S 13/88; G01S 13/89

(52) U.S. Cl. CPC G01S 7/412; G01S 13/887; G01S 13/89

(57) ABSTRACT

Examples are directed toward a system and method relating to visualizing objects. For example, a system includes at least one transceiver that emits millimeter wave (mmW) energy and senses reflected mmW energy at a plurality of frequency bands of mmW frequencies, as reflected by an object. The system also includes a display and a controller coupled to the at least one transceiver and the display. The controller converts the plurality of reflected mmW energies, at the plurality of frequency bands of mmW frequencies, to a respective corresponding plurality of color contributions that contribute toward a display color. The controller combines the plurality of color contributions to generate the display color, and the controller outputs, using the display, a visualization of the object depicted using the display color.

### CROSS-REFERENCE TO RELATED APPLICATIONS

This is a nonprovisional application that claims the benefit of priority from U.S. Provisional Application No. 63/671,438 entitled “Materials and Anomalies Identification Methods and Systems Using Millimeter Wavelengths,” filed on Jul. 15, 2024, the contents of which is incorporated herein by reference in its entirety.

### STATEMENT OF GOVERNMENT INTEREST

The claimed subject matter was made by one or more employees of the United States Department of Homeland Security in the performance of official duties. The Government has certain rights in the invention.

### FIELD

The present subject matter relates generally to the field of scanning and evaluating objects, and more specifically to the field of using millimeter wavelengths.

### BACKGROUND

Millimeter wavelength (MMW) scanning is used to detect objects even if concealed underneath clothing. However, the technology obtains images that are monochromatic, due to the failure to distinguish different colors of the reflected MMW energy. This creates difficulty for operators to distinguish whether the scan indicates an alarm condition.

### SUMMARY

In an embodiment, a system to visualize objects includes at least one transceiver that emits millimeter wave (mmW) energy and senses reflected mmW energy at a plurality of frequency bands of mmW frequencies, as reflected by an object. The system also includes a display and a controller coupled to the at least one transceiver and the display. The controller converts the plurality of reflected mmW energies, at the plurality of frequency bands of mmW frequencies, to a respective corresponding plurality of color contributions that contribute toward a display color. The controller combines the plurality of color contributions to generate the display color, and the controller outputs, using the display, a visualization of the object depicted using the display color.

In another embodiment, a method to visualize objects includes emitting, by at least one transceiver, millimeter wave (mmW) energy, and sensing, by the at least one transceiver, reflected mmW energy at a plurality of frequency bands of mmW frequencies, as reflected by an object. The method also includes converting, by a controller coupled to the at least on transceiver and a display, the plurality of reflected mmW energies, at the plurality of frequency bands of mmW frequencies, to a respective corresponding plurality of color contributions that contribute toward a display color. The method includes combining, by the controller, the plurality of color contributions to generate the display color, and outputting, by the controller using the display, a visualization of the object depicted using the display color.

Other features and aspects will become apparent from the following detailed description, which taken in conjunction with the accompanying drawings illustrate, by way of example, the features in accordance with embodiments of the claimed subject matter. This summary is not intended to identify key or essential features of the claimed subject matter, nor is it intended to limit the scope of the claimed subject matter, which is defined solely by the claims attached hereto.

### BRIEF DESCRIPTION OF THE DRAWINGS

One or more embodiments of the subject matter are described in detail with reference to the following drawings. These drawings are provided to facilitate understanding of the present subject matter and should not be read as limiting the breadth, scope, or applicability thereof. For purposes of clarity and ease of illustration, these drawings are not necessarily made to scale.

FIG. 1 illustrates a system according to an embodiment.

FIG. 2 illustrates a chart of skin spectra extracted according to an embodiment.

FIG. 3 illustrates a chart of skin colors and plastic colors according to an embodiment.

FIG. 4 illustrates a flowchart to visualize objects according to an embodiment.

FIG. 5 illustrates a flowchart to obtain a hexadecimal color value according to an embodiment.

These drawings are not intended to be exhaustive or to limit the subject matter to the precise form(s) disclosed. It should be understood that the present subject matter can be practiced with modification and alteration, and that the subject matter is limited only by the claims and the equivalents thereof.

### DETAILED DESCRIPTION

Embodiments enable scanning and evaluating the spectral signatures produced by objects, to quantify reflectivity differences in millimeter wavelengths (mmW) reflected by objects, referred to herein as the mmW color of objects. Embodiments enable techniques to visually display those mmW color reflectivity differences, using display color that is readily apparent to an operator, allowing the operator to effectively see the mmW color of objects translated into display color. Unlike false-color approaches that arbitrarily assign false colors according to shapes or other geometric characteristics orthogonal to mmW color, embodiments described herein map specific display colors to objects, based on specific mmW reflected wavelengths by correlating those specific mmW reflected wavelengths to specific display colors.

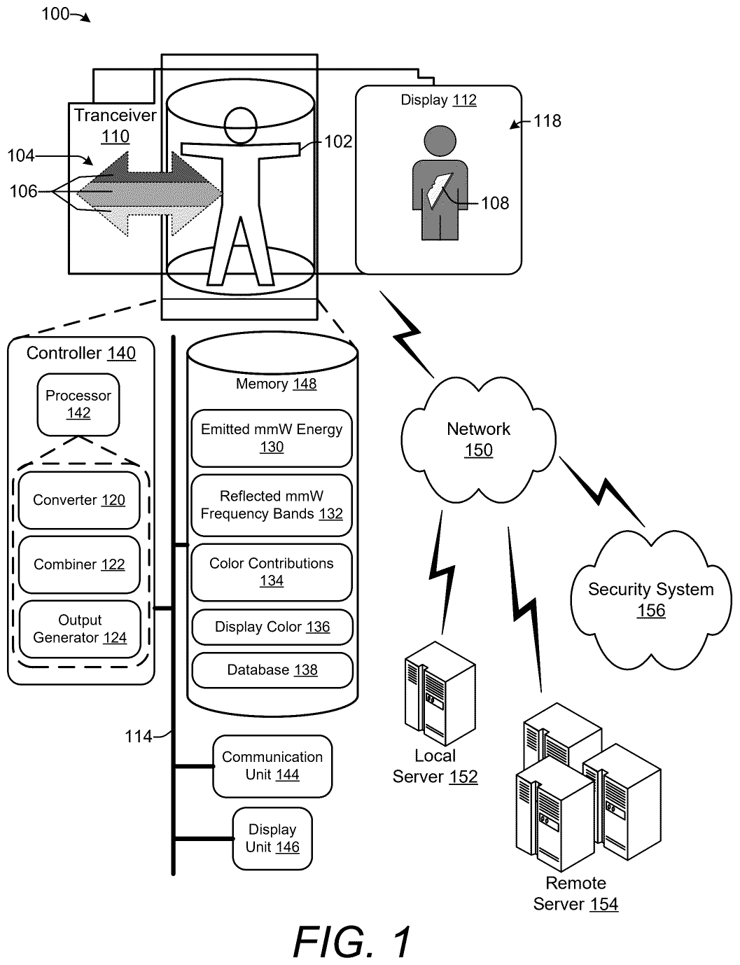

FIG. 1 illustrates a system 100 to visualize objects 102 according to an embodiment. Embodiments can include: an emitter, such as a transmitter, transceiver 110, or the like, to emit mmW energy 104 including one or more mmW frequency bands 106 (also referred to herein as sub-bands); and a receiver, including a transceiver 110 or the like, to measure/sense frequencies from the object 102, of the one or more frequency bands 106. The embodiments can determine a frequency curve, which is determined to fit the one or more sensed frequency bands or portions of the curve, and embodiments can extrapolate and reconstruct unsensed parts of the curve from the measured reflected frequencies. The system 100 can be in communication via network 150 with local server 152, remote server 154, and security system 156 (such as a system for performing communications in connection with security scanning). The system 100 includes controller 140 coupled via a bus 114 to memory 148, communication unit 144, and display unit 146. The controller 140 includes a processor 142 to execute converter 120, combiner 122, and output generator 124.

The memory 148 is associated with emitted mmW energy 130, reflected mmW frequency bands 132, color contributions 134, display color 136, and database 138. The processor 142 can determine the color contributions 134 by sensing the reflected mmW frequency bands 132 of the mmW energy 104, and using converter 120 to convert the reflected mmW frequency bands 132 to color contributions 134. The processor 142 can using combiner 122 to combine the color contributions 134 into display color 136. The processor 142 can use output generator 124 to cause display unit 146 to generate a visualization 118 of the object 102 displayed on the display 112. The visualization 118 includes a depiction of an anomaly 108, due to the different mmW color exhibited by the anomaly as compared to the mmW color of the human skin of the object 102, demonstrating a readily perceived discontinuity of color between the two objects that exceeds a detection threshold. The depiction of the anomaly 108 therefore visually stands out in a different display color on the display 112, compared to the display color of the human skin.

The system 100 includes one or more communicatively coupled communication units 144, processors 142, and memory 148. The communication unit 144 is representative of one or more devices able to communicate information to or from other devices and components including in instances those included in or external to the system 100. Example communication units 144 include but are not limited to wireless modems (such as an 802.11 compliant unit), wired (e.g., Ethernet-ready) or other such communication interfaces, or a cellular communication transceiver. Example 802.11 compliant modems or cards include but are not limited to those compliant with 802.11n, 802.11ac, 802.11ad, 802.11ah, 802.11aj, 802.11ax, and the like wireless local area network standards promulgated by the Institute of Electrical and Electronics Engineers (IEEE), New York, New York.

Although a single processor 142 and memory 148 are shown, the system 100 can be constructed with multiple processors and memory. The processor 142 is representative of hardware that is capable of processing computer executable instructions, such as a central processing unit that executes a program of instructions. In embodiments, the processing unit (processor 142) implements an operating system which is a set of instructions that allows the processor to perform specialized instructions according to a program run on the operating system or processor platform.

Local memory 148 is representative of a wide variety and types and combinations of memory suitable for storing information in an electronic format. Example memory includes but is not limited to random access memory (RAM), hard disk memory, removable medium memory, flash storage memory, and other types of computer-readable media including non-transitory data storage.

In embodiments, the controller 140 is representative of hardware or software that is constructed to function as described in this disclosure. For example, the controller 140 is a combination of software (such as a program of instructions that is stored in local memory) that is useable by the processor 142 to provide the described capabilities and functions, such as when the embodied instructions are executed by the processor 142 included in the system 100. As illustrated and for case of understanding, the controller 140 includes the processor 142 and the various illustrated modules, and other logic or features described herein. While shown and described as individual modules, the supporting hardware or software can be configured as an integrated program of instructions to provide the described functionality, such as through the use of application program interfaces (APIs) that permit individual programs to interface to one or more other programs and provide one or more graphical user interfaces (GUIs) output on a display unit 146 to a user to access information or exercise control over the system 100 including a visual display output.

Embodiments can be based on hand-held hardware, such as hand-held wands for scanning objects for security screening. As used herein, the term object 102 includes people, in addition to non-human baggage or other objects carried through security checkpoints for travel, and the like. Embodiments of system 100 also can be based on stand-alone versions, such as security scanners with conveyor belts, chamber scanners for scanning passengers standing in the chamber, and the like.

The spectral methods being used in IDX (Identification of Explosives) in millimeter-wave imaging employ logistic regression based on dielectric detection and correlations in spectral characteristics. Because logistic regression is a linear combination of these parameters, it may be undermined by the observed variability in reflection magnitude. “Color” is a characteristic of changing intensity at varied frequency, as can be defined in terms of intensity ratios across the frequency band. We extend this definition of color to millimeter-wave spectra, represented in FIG. 1 as mmW energy 104 including one or more frequency bands 106. We describe techniques herein to include the color parameters in the logistic regression to pick up on spectral features due to dielectric dispersion and conductivity, and create meaningful false color millimeter-wave images such as the visualization 118 which visually distinguishes color of the object 102 versus color of the anomaly 108, based on the underlying mmW colors themselves (in contrast to the shapes or textures) exhibited by the reflectance of the objects.

The distinguishing spectral characteristics of explosive gels and slurries is predicted from their anticipated conductive qualities. These opaque materials lack interference spectra but will be more reflective at low frequencies where the conductivity is enhanced (conductivity varies as 1/f). Conductivity is measured in terms of imaginary component of dielectric constant, so this property—if detected—can be quantified as a material-specific parameter. The logistic regression might be expected to identify the conductivity spectrum by its shape, but this may only be true if the absolute reflectivity is accurately calibrated. This is because the measures in the logistic regression analysis are incorporated linearly. An advantage of the color technique described herein is that we can define the color as a ratio of intensities (through a logarithm as described below), so color can be derived from the relative reflectivity. The method also applies well to quantify spectral signatures due to dielectric dispersion effects and for scattering. The method also applies to materials that do not have transparency resulting in back surface reflection.

In an embodiment, we characterize the reflection intensity using three of the illustrated frequency bands 106:12-16 GHz; 21-25 GHz; and 30-34 GHz. For each band f_{A}<f<f_{B} with N frequencies,

$${\overline{r}}_{{f}_{A} - {f}_{B}} = \frac{1}{{N}_{{f}_{A} - {f}_{B}}} {\sum }_{{f}_{i} > {f}_{A}}^{{f}_{i} < {f}_{B}} \vert {r}_{i} \vert \qquad Equation ( 1 )$$

Consider frequency sub-band 12-16 GHz as an example. The minimum band frequency f_{A} is 12 GHz for that sub-band. The maximum band frequency is f_{B} is 16 GHz. The data collected consists of N values of reflectivity rᵢ and frequency fᵢ. In this sub-band, there are N_{f}_{_{A}}_{f}_{_{B}}=69 data points (out of the total 512 data points collected). The subscript i is a counter index. As a subscript, i denotes the i^{th} value of the data. The frequencies in this sub-band use 34≤i≤102, such that f₃₄=12.05 and f₁₀₂=15.99 (within the band f_{A} to f_{B}). There is a reflectivity rᵢ associated with each value fᵢ. Equation 1 defines an average reflectivity over a band: the bar above r denotes an average and the subscript denotes the band; in this example, r̅₁₂₋₁₆ indicates the average over the frequencies f_{A} to f_{B} for this sub-band. The sum Σ includes all the frequencies in the band from f_{A} to f_{B} or i between 34 and 102. The summand is |rᵢ|, where the vertical pipes indicate absolute magnitude of rᵢ, which is a complex (real and imaginary) number. N_{f}_{_{A}}_{-f}_{_{B}}=69 in this example.

These frequency bands or sub-bands 106 are arbitrary, but there is an advantage to using a low frequency for the low frequency band, for the sake of a conductivity signature. The purpose of the average is to improve the measurement from noise. In the absence of absolute calibrated reflectivity—which is challenging due to variation in tilt, texture, and shape—a preferred metric that can be used is a ratio of spectral intensity, which is a measure of “color.” We implement this definition of color as a difference in intensity logarithm. Among the three bands, we characterize two color measures:

$${color}_{1} = log {r}_{12 - 16}^{-} - log {r}_{21 - 25}^{-} \qquad ( 2 )$$

$${color}_{2} = log {r}_{21 - 25}^{-} - log {r}_{30 - 34}^{-} \qquad ( 3 )$$

where color₁ is associated with the lower frequency range, and color2 with the higher frequency range. The use of two colors rather than one is useful to select for conductive materials by the color excess between low and high frequency.

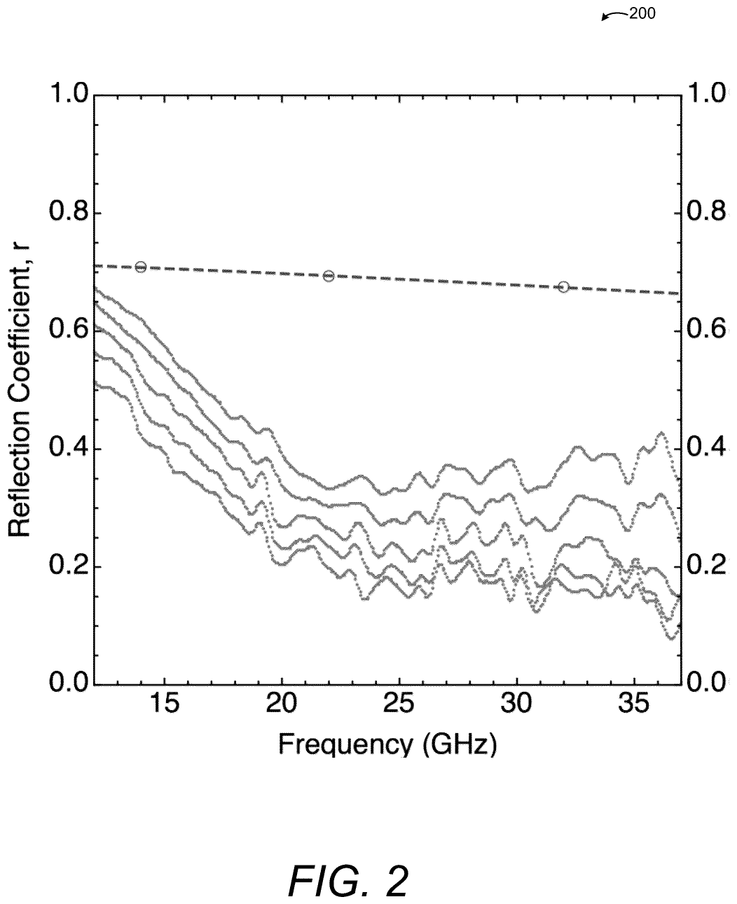

Embodiments can use scanning equipment such as system 100 to sense data corresponding to the frequency bands 106. That data from each of the frequency bands 106 represents a portion of a curve. The portions can be discontinuous, if there are gaps in the sensed frequencies representing the frequency bands. For the example frequency bands 106 set forth above (12-16 GHz; 21-25 GHz; and 30-34 GHZ), there is a 5 GHz gap between each frequency band 106. Embodiments can determine an overall continuous curve, which fills in the gaps between the one or more sensed portions of that curve, by extrapolating and reconstructing the ‘missing’ parts corresponding to the unsensed portions of the curve. Alternatively, the system can measure data continuously without gaps, as illustrated in FIG. 2. Embodiments extrapolate and reconstruct based on the characteristics of the subject material. When the subject material is opaque, embodiments extrapolate and reconstruct based on expecting the reflection curve to be relatively simple over a given reflectivity band. Specifically, in the case of an opaque target, embodiments assume the reflectivity does not vary if the permittivity (aka dielectric “constant”) is constant. However, the dielectric constant can vary for several reasons: if it has a finite ionic conductivity (such as water-based liquids, and explosive gels and slurries), if the material has a classical Debye relaxation (see the Agilent Application Note 5989-2589EN for reference), and so on. Given the influence of these dielectric variations across a finite measurement frequency band, the otherwise constant linear reflectivity from the mean dielectric constant might have a small tilt and possible small curvature; the effects can be manifested in the reflectivity and characterized with the color parameterization. The small variation in reflectivity can be associated with the dielectric constant, which is an intrinsic material property and therefore has potential for identification.

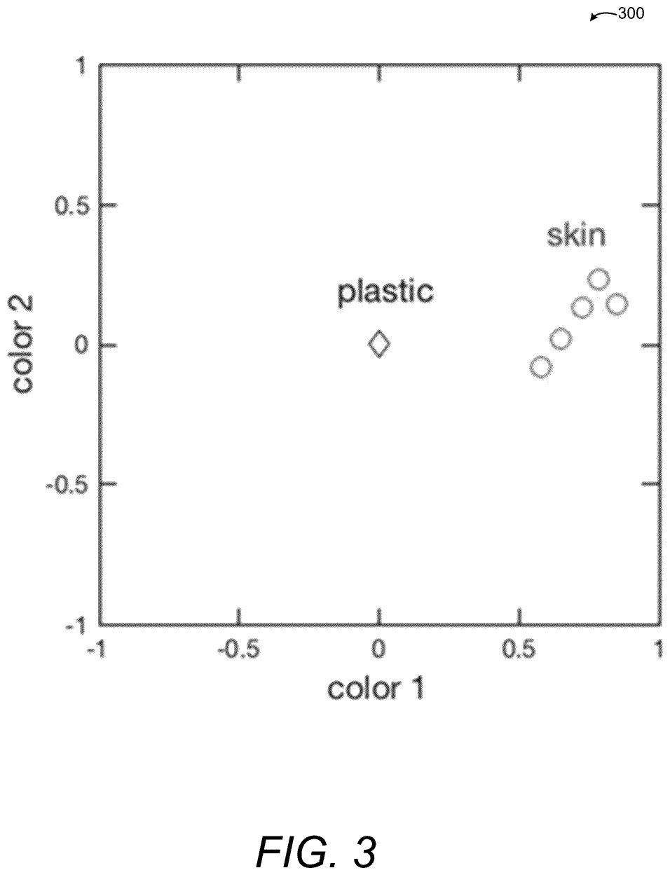

As used herein, the terms transparent, semi-transparent, opaque, etc. refer to characteristics of objects and materials in terms of mmW energy and scanning. The reflection from a semi-transparent plastic material is exemplified in FIG. 3 of Weatherall, J. C., Barber, J. and Smith, B. T., 2016. Spectral signatures for identifying explosives with wideband millimeter-wave illumination. IEEE Transactions on Microwave Theory and Techniques, 64(3), pp.999-1005. (Weatherall, et al. (2016)), where the curve derives from constructive and destructive interference from the front and back surfaces. This is related to an Identification of Explosives (IDX)-related patent (U.S. Pat. No. 8,946,641, hereafter “the '641 patent”). FIG. 3 of Weatherall, et al. (2016) illustrates the advantages attached to a broadband of frequency available from Advanced Imaging Technology (AIT) systems, which use a broadband of frequencies for imaging resolution. Note that the current disclosure addresses materials for which the optical interference technique depicted in FIG. 3 of Weatherall, et al. (2016) may not be ideal, because there is no signal from the back surface when the target is opaque, so such materials may pose challenges for those optical interference techniques of Weatherall et al., unlike the embodiments disclosed herein. The curve of an opaque material is exemplified in FIG. 6 of Weatherall, et al. (2016)

Embodiments quantify signatures of objects in the reflective space, without needing to measure the dielectric constant. For transparent or semi-transparent materials, the reflectivity is a function of both the environment (such as material thickness and objects behind the material) and the intrinsic property of the material (dielectric constant). When the material is opaque, the reflectivity is a function of only the dielectric constant—disregarding other optical attributes associated with the object such as its size, surface flatness, and surface orientation. This means the material composition and its dielectric constant can be inferred, in principle, directly from its reflectivity without further analysis to isolate it from its environment. For opaque materials, these parameters have the following mathematical relationships:

TABLE 1
Mathematical Relationships for Opaque Materials

| | |
|---|---|
| Dielectric constant | ε = ε + i ε″ |
| Index of refraction | n = √ε |
| Reflection coefficient | r = (n − |
| (normal incidence) | 1)/(n + 1) |

Embodiments can directly quantify the reflectivity by a measurement instrument such as a transceiver 110 consisting of an antenna (or antennas in the case of an imaging system) calibrated to measure the return signal from the target object 102. The reflectivity measurement is based on the ratio of the transmitted signal voltage to the reflected signal voltage of the antenna transceiver. The dielectric constant is a derived quantity based on the use of a physical model to relate the reflectivity to the dielectric constant (such as by using table 1 above). For the simplifying case of opaque materials, the reflectivity and dielectric constant are expressions of the same physical information.

It can be challenging to measure the dielectric constant of materials that are opaque. Embodiments can rely on the front surface reflection, or reflectivity, of materials. Embodiments can identify trends in the measured spectra. Trends are identified by constructing ratios of integrated reflection energy (magnitudes) over sub-bands of the frequency spectrum. This is equivalent to subtraction of logarithms of the sub-band measures. Embodiments can capture those trends using the metric referred to herein as mmW color.

Embodiments can synthesize data across available bandwidth for a specified dielectric constant. The synthesis of data is the integration of the reflection coefficient over the sub-bands of frequency. The integrated reflectivity is a dimensionless quantity. The radiation intensity reflected in the sub-bands is detected, but this quantity may not be used in all approaches because embodiments can synthesize the data as ratios of the sub-band integrations, and the physical conversion thereby factors out. For a simple reflectivity function and for data of ordinary quality as detected by AIT instruments, the integration can be approximated by averaging over the frequency sub-band.

Embodiments can separate the available bandwidth into distinct/discrete frequency bands 106, characterize the material based on the reflectivity, and assign a false-color map to the reflectivity in those discrete bands. For example, an embodiment uses three segments of the available bandwidth, to generate mmW color information that is translated into a corresponding three colors of a red/green/blue (RGB) map, for determining a corresponding display color to represent the mmW color on display 112.

Embodiments can use any combination of frequency sub-bands (also referred to herein as frequency bands 106) to divide up the available frequency bandwidth (e.g., as available from the AIT). Embodiments also can use sub-bands that are contiguous or non-contiguous. The provided example above uses non-contiguous sub-bands with gaps of 5 GHz between frequency bands 106 to illustrate and emphasize differences in the sub-bands. To quantify a small (linear) trend in reflection requires at least two data points at the low and high ends of the frequency band. Also, a small departure in linearity (associated with a relaxation frequency or conductivity enhancement toward lower frequency) might be evident, and embodiments can use a third data point, or more data points, to quantify the nonlinear trend.

Embodiments also can use other bandwidth segments and mappings, e.g., using four segments of bandwidth (frequency bands 106) mapped to four display colors such as CMYK, and so on. A four sub-band segmentation of frequency bands 106 is possible by dividing the band into four non-overlapping segments, e.g., by using scaling values to select sub-bands. Embodiments also can break the spectrum into segments and integrate or average the results, providing the advantage of reducing errors due to fluctuations (e.g., noise) in the spectrum. The full spectral information is available from the AIT measurement system 100, so embodiments are not limited in the definition of particular sub-bands of bandwidth. However, because of the variation in reflectivity, embodiments can derive valuable information without needing to use more segments. The expression of color mapping was accomplished using three segments with the hexadecimal scheme as set forth below, but the display is not necessarily limited to hexadecimal color. For example, the CMYK scheme is suitable for print color rendering due to the four pigment-based colors, in contrast to electronic display color rendering due to using three emissive-based colors such as RGB.

Embodiments can apply the techniques described herein to identify materials, such as human skin of a human object 102 versus plastic or metal of an anomaly 108. In an embodiment, identification is based on using a materials database 138. The database 138 can be informed by direct imaging or laboratory measurement of the dielectric constant of various materials that are to be identified, such as various threat materials encountered in security scanning. Embodiments can use a “logistic regression” statistic to identify the best match between a scanned material and a material from the materials database 138, the logistic regression being a useful method to determine which material is “closest” when there are multiple inputs.

Embodiments measure differences in reflectivity as a function of frequency. Embodiments can use discontinuity of mmW color to detect objects, and display the discontinuity using display colors. For example, a dielectric slab can serve as a test object that is placed on skin of a person. The dielectric slab, when scanned on the skin, locally modifies the mmW color that would otherwise be reflected by the skin. Accordingly, embodiments can detect the dielectric slab, by using the mmW color as an additional anomaly identifier. Embodiments can detect the skin as a generally uniform mmW color, and detect the dielectric slab on the skin, even if partially transparent or opaque to mmW, because of the difference in detected mmW color associated with the dielectric slab compared to the skin. Embodiments thus can display or detect objects, such as the dielectric slab, using display colors. For example, an example system can display the dielectric slab as, e.g., a blue box, on a red background representing the skin. Embodiments detect discontinuity of mmW color in that region, e.g., by detecting where a mmW color change (blue vs red) reaches a threshold, and can alarm on the detection.

Embodiments can be installed, e.g., as a firmware or software update, to augment controllers 140 of existing scanning machines that use mmW technology to scan and acquire mmW images of objects 102. The embodiments can be applied using software development as an add-on module to existing scanning machines. The scanning machines can include HDR automatic target recognition computers, to analyze mmW data to identify anomalies by sensing shapes. The scanning machines, such as AIT machines, can be modified according to embodiments so that, instead of imaging for only shapes/textures, the embodiments enable the scanning machines to also image mmW colors of the object being scanned, such as by enabling the scanner to generate a mmW color image of the scanned object. The example scanning machines can translate the mmW colors into display colors, and display a visualization of the scanned object using the display colors that map to the mmW colors. Thus, the scanner acquires and displays mmW images of scanned objects by using display colors to visualize the color of the scanned objects, including the mmW color of the skin of human passengers. If there is an anomaly 108, the anomaly 108 is readily visualized using a different display color than the skin, corresponding to the different mmW color of the anomaly 108 compared to the mmW color of the passenger's skin. In an embodiment, the system can use the mmW colors to identify what material comprises the object being scanned, e.g., by referencing a database 138 of material properties.

Embodiments can use mmW colors as follows: the reflectivity of skin decreases by 30-60% across the frequency band from 10 GHz to 40 GHZ, producing the colors distinguishable from plastics, as set forth below in Table 4 (mmW False Color). The dielectric constant of plastic, in contrast, is constant over the frequency band, which is characteristic of some types of explosive threats that might be encountered at security checkpoints. Embodiments described herein use this principle to display such plastic or threats using gray shades of display color based on application of the mmW color techniques described herein. The use of plastic is a convenient surrogate for military explosives when training agents using the mmW color scanning techniques, because plastic and explosives have similar dielectric constants, although plastic is less absorptive and would need to be quite thick to actually be opaque. Accordingly, by using mmW color, an embodiment can generate visualizations 118 of objects that inherently distinguish objects like plastic or military explosives that are displayed in grayscale, in contrast to human skin or other objects that are displayed in color.

Approaches described herein can leverage AIT technologies. AIT devices can specify a target, using the Automatic Target Recognition (ATR) software of the AIT. Embodiments can then apply IDX methods to identify the specified target as either benign or a potential threat (such as an explosive). Embodiments can use thresholding when applying the mmW color technology to evaluate or inform decisions made by the ATR employed by the AIT.

Accordingly, embodiments enable scanning machines to acquire not only the texture of the object/anomaly for identification, but also to acquire and use mmW color of the object/anomaly for identification. Thus, embodiments increase the accuracy of the scanning machines and reduce the number of false alarms and reduce the number of operator calls to perform secondary screening for anomaly resolution of scanned objects.

FIG. 2 illustrates five samples of skin spectra extracted with IDX from PNNL HD data. The dashed line is a theoretical prediction based on a skin Debye model. The illustrated IDX-derived spectra are based on PNNL images of skin. The data shown in FIG. 2 is for five individual spectra. Note that the shape of the spectra is consistent even though the absolute reflectivity varies by site. The derived band-averaged reflection coefficients and colors are given in Table 2 and Table 3, respectively.

TABLE 2
Skin reflection coefficient r̅ in bands

| Sample | 12-16 GHz | 21-25 GHz | 30-34 GHz |
|---|---|---|---|
| 1 | 0.436 | 0.187 | 0.162 |
| 2 | 0.484 | 0.219 | 0.174 |
| 3 | 0.531 | 0.255 | 0.223 |
| 4 | 0.573 | 0.298 | 0.293 |
| 5 | 0.609 | 0.339 | 0.367 |

We can compare the IDX reflection data to analytic reflection predictions based on measured skin dielectric properties. A useful skin Debye model is given by Alekseev and Zisken: ε=4.0+32/(1-2iπf0.0069)−1.4/(2iπf0.0088). In the Debye model, the first term is high frequency limit of the permittivity. The second term incorporates the dielectric relaxation and its time scale. The third term incorporates the conductivity. The model projects skin colors color₁ and color₂ that are smaller and more consistent than observed in IDX, so the color differential is likely associated with characteristics other than dispersion or conductivity, such as scattering.

TABLE 3
Skin color index in MMW

| Sample | color₁ | color₂ |
|---|---|---|
| 1 | 0.85 | 0.14 |
| 2 | 0.79 | 0.23 |
| 3 | 0.73 | 0.13 |
| 4 | 0.65 | 0.02 |
| 5 | 0.58 | −0.08 |
| Mean | 0.72 | 0.11 |
| Std dev | 0.11 | 0.12 |

The possibility of separating materials relates to the reflection ratios across bands of millimeter-wave frequency and the change with frequency: these ratios represent millimeter wave color, as defined here as differences in logarithm of reflectivity in different bands. Materials that have constant reflectivity across the bands would have zero color measure at all frequencies. Because of dispersion, conductivity, and scattering effects, materials may have distinguishing color properties.

While we characterize the millimeter-wave intensity ratios as color, there is a direct analog to color using three bands in the sense of Red Green Blue (RGB). False color created this way can be used for visual presentation when the spectral reflectivity is collected on the whole image and separated. Alternatively, three images can be constructed in the sub-bands to extract the three intensity values. Table 4 illustrates converting the three reflection measures into hexadecimal colors. The reflection coefficients are first expressed in 8-bit by multiplying by 256, and converted to hexadecimal (e.g., using the Excel DEC2HEX function). The hexadecimal color is formed by concatenating the three hexadecimal reflection coefficients. This produces distinct colors for the skin spectra versus spectra without enhanced reflectivity at lower frequencies. In this color scheme, materials whose spectra are flat would appear in shades of grey between white (perfectly reflective) and black (perfectly absorbing), while materials with spectra decreasing with frequency appear with shades of red.

This measure of color may be missed in logistic regression because the logistic regression is constructed from linear combination and does not incorporate ratios. One approach to including color in logistic regression is to use the logarithm of reflection magnitude. Then the regression could discover positive and negative signs in logarithms as correlations. Alternatively, the color can be incorporated explicitly as defined here.

To restate: An example system collects reflectivity spectra values for different samples. The example system uses the collected values and performs a first calculation using equation (1) to find the mean of reflectivity values within the given band, the mean being represented by r̅_{f}_{_{A}}_{-f}_{_{B}} where f_{A}-f_{B} represents a band of reflectivity frequencies between a first frequency f_{A} and a second frequency f_{B}. Example values for the mean are shown in Table 2, for three bands of reflectivity frequencies. The example system uses the values from table 2 to assign mmW colors, as shown in Table 4. The system can use equation 1 to obtain the values shown in table 2, those values also being used in Table 4 (scaled to HEX colors), without needing to use equation (2), equation (3), or table 3. The expression of HEX colors in Table 4 is based on the measurements in Table 2. The definition of color in Table 3 is a separate method. The former (Table 4) is designed to display material properties visually; the latter (Table 3) is a quantitative method.

Color₁ and color₂ have physical significance as ratios of reflectivity in the spectrum sub-bands and work separately from the HEX color scheme (which is an arbitrary assembly of color). The use of color₁ and color₂ are exemplified in FIG. 3, where the targets (plastic and skin) can be separated in different regions in the color space, i.e. they have different “color.” An interesting parameter space is the two-dimensional space constructed with color₁ and color₂. The millimeter-wave reflection properties relate to dielectric constant-particularly the dielectric loss.

FIG. 3 illustrates skin color index in color-color space from Table 3. Plastic is given as an example of a material with uniform reflectivity—colorless in this space. The colors in Table 3 are calculated from the measured reflection values in Table 2. The colors are calculated from the data using Equations (2) and (3).

Example systems can apply equations (2) and (3), by subtracting the logarithms of the reflectivity means for given reflectivity bands, to achieve a measure of mmW color between two reflectivity bands. The use of log reflectivity, logarithm of the ratio of the reflectivity, or logarithms, relates the differences to physical properties of the materials, and is independent of geometric factors such as tilt and target size that might affect the reflectivity measurement. Example values for logarithms are found in Table 3 above.

Table 3 illustrates values resulting from intermediate calculations to determine color₁ and color₂ for five samples. The values can be used as differences in reflectivity logarithm to calculate the mmW color, serving as a metric for color. Table 3 represents the log of the reflectivity ratio (equivalent to the difference of the reflectivity logarithm) as expressed in the color measures equations (2) or (3), essentially expressing ratios between values of reflectivity bands.

A larger data set may define regions of the color-color space that represent threats versus regions of color-color space that are characteristic of benign or false alarm materials. The information in Table 4 is derived from the same data, but instead of making the distinction by spatial separation in the graphic space of FIG. 3, the data in Table 4 is depicted as color and can be applied to an image or avatar-image in a visual display. A plus is that the Table 4 visual color display includes information on absolute intensity (brightness), whereas FIG. 3/Table 3 is relative brightness.

Embodiments also can define mmW spectrum bands and colors that are different than those illustrated for RGB. For example, an approach is to apply a transformation function to the reflectivity data to increase sensitivity or elicit different colorations. Transformational techniques can generate color in an image, e.g., by taking data from near-infrared, red and green bands, and generating a synthetic blue color channel using a polynomial function. An example transformational technique can be found in S. Kala, et al. “An algorithm for generating natural color images from false color using spectral transformation technique with higher polynomial order.” The International Archives of the Photogrammetry, Remote Sensing and Spatial Information Sciences 42 (2018): 643-648. https://doi.org/10.5194/isprs-archives-XLII-5-643-2018. Such techniques can provide a more natural color scaling to images. Embodiments can apply polynomial functions to the mmW frequency data, to generate higher or lower frequency color channel(s). This enables embodiments to make objects of interest stand out even further, or make the human body appear a different color. Embodiments can apply transformational functions to images, to change the appearance of the person to another color, such as a uniform gray. An embodiment can subtract the expected signal of an average human body from the obtained signal, making the person potentially “disappear,” leaving the anomalies themselves behind. Such an approach also serves as a privacy algorithm, to remove the appearance of the human body from images that are reviewed for anomalies.

Embodiments can assign the RGB display color that arises from performing the calculations on the sensed reflectivity bands. An example system can use an RGB mapping to assign hex values corresponding to the mean values for multiple bands. The example system can concatenate the hex values together into a concatenated hex value, and use the concatenated hex value to perform a color lookup, e.g., using an HTML color code lookup table. Embodiments can use other schemes or tools to map colors differently, such as a color code converter to convert the scaled reflectance mean values to display color channels or weightings etc.

An example system weights the sensed mmW color values in a manner that causes the system to generate different red shades of display colors to represent different mmW colors of skin. The system captures the largest reflectivity information from skin in the lowest band, which the system then converts into red display colors. The example system associates shades of red with the lowest mmW frequency band in this embodiment. However, in other embodiments, shades of green or blue can be used to represent types of skin. Skin is expected to be more reflective at lower mmW frequencies rather than higher mmW frequencies.

Embodiments can generate display colors mapped to mmW colors by scaling the reflectivity value, which goes from 0 to 1 for a given band. An example system hexadecimally scales the 0-1 reflectivity values to scaled values of 0-255. For RGB display colors, the system maps reflectivity 0-1 to hexadecimal color values 00-FF. All zeros (00 for two-digit hex) represent display color black, and all F's (FF for two-digit hex) represent the display color white.

Embodiments can use mmW colors of multiple reflectivity bands, to generate additional display colors. An example system can generate a six-digit hexadecimal code for the color, by synthesizing the three reflectivity bands shown in Table 4. For example, the example system maps each band to its scaled hex value color, and then concatenates those three colors to contribute to the R, G, and B channels that make up the color. Thus, the example system treats each mmW band of reflectivity as though it were a band of a color channel contributing to an overall display color.

A benefit arising from the approaches used in the example systems, is that an example system can display objects such as plastic in display colors that are grays or grayscale, which lack color and are therefore easily distinguished from colorful human skin by operators who view the displayed output of security scanners. This is because embodiments take advantage of mm W reflectivities. For materials such as plastic, the mmW reflectivity is fairly flat across the entire mmW band, resulting in a generally gray display color. This principle is related to how, if a material's dielectric does not change as a function of frequency, then the reflectivity would not change either assuming the material is absorbing and the reflection is exclusively from the front surface. Accordingly, the individually selected bands of mmW reflectivities of such materials, as sensed by embodiments, will not change across all of the bands, when sensing objects made of plastic or similar materials having flat mmW reflectivity characteristics. The example system senses reflectivity for such materials that are relatively similar across multiple mmW bands, which the example system translates from mmW color to displayed color. In that translation, the example system generates display color channels that, for plastic and similar ‘colorless’ materials, do not have relatively more of one color than another between channels, so the resulting composite display color is in grayscale without displayed color shading. Accordingly, the example system readily distinguishes plastic and similar materials by displaying such objects as gray in display color, because those objects have flat mmW reflectivity responses.

Most materials have a uniform and constant dielectric constant across the relatively small bands that mmW instrumentation allows. Measurement systems are typically constrained to standard radio frequency bands (K-band, V-band, etc.) because the signal is transmitted to the antenna through waveguide, and the bands enable the propagation of signal in waveguides that have a single mode of wavelength, and frequencies out-of-band either do not propagate or have multiple modes that corrupt the measurement.

An exception, to the uniform dielectric constant across the band, is water-based materials that have a substantial “relaxation” in the mmW frequency that cause the dielectric to change significantly-and for food to heat in microwave ovens. The choice of bands for embodiments is opportunistic, taking advantage of the data from available AIT systems, which are generally in the region containing K-band 20-30 GHz. If optimizing sub-bands, embodiments can select, in addition to K-band, S-band at 2-4 GHz to capture conductivity effects that are more pronounced at lower frequency, and W-band 75-110 GHz to capture dielectric relaxations of more materials.

Embodiments can define skin via a color palette, and subtract out areas of bare skin corresponding to the color palette, leaving only objects/anomalies behind for evaluation, whether evaluated by ATR systems, human operators, or the like. Such embodiments can therefore ensure passenger privacy, by ensuring that human skin is not displayed, only the objects/anomalies are displayed.

In mmW spectra, reflectivities can change in different frequency bands when it comes to materials opaque to mmW. For example, mmW reflectivity is affected by conductivity of the material (which affects mmW absorption), or a dielectric relaxation of the material. Such characteristics can cause distortions and other changes to the reflected mmW energy. Embodiments can make use of the dielectric relaxation properties of liquids, to create display colors that cause different liquids to be visually distinct. For example, water, ethanol, and methanol have different dielectric relaxation properties, as is known from Bao, et al. (Bao, Jian-Zhong, Mays L. Swicord, and Christopher C. Davis. “Microwave dielectric characterization of binary mixtures of water, methanol, and ethanol,” Journal of Chemical Physics 104, no. 12 (1996): 4441-4450); we expect a different color response in mmW, though maybe subtle. Some of these relaxation effects are temperature sensitive, so color could potentially be used to detect temperature differences. MmW color can also have a role in monitoring chemical reactions, conductivity in batteries, spoilage in food, and fermentation of spirits.

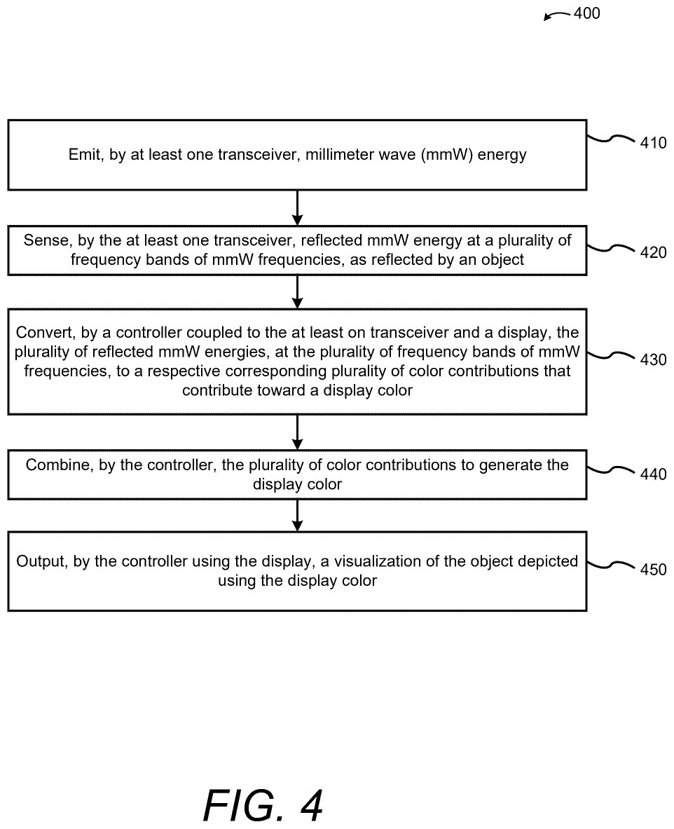

FIG. 4 illustrates a flowchart 400 to visualize objects according to an embodiment. At 410, at least one transceiver emits millimeter wave (mmW) energy. For example, a security scanning system includes a transceiver with at least one antenna to scan an object using mmW energy. At 420, the at least one transceiver senses reflected mmW energy at a plurality of frequency bands of mmW frequencies, as reflected by an object. For example, the at least one antenna of the system receives a range of mmW frequencies, which can be grouped into bands of frequencies such as those shown in Table 2 above. At 430, a controller coupled to the at least on transceiver and a display converts the plurality of reflected mmW energies, at the plurality of frequency bands of mmW frequencies, to a respective corresponding plurality of color contributions that contribute toward a display color. For example, each band exhibits a range of reflectivity, as shown in FIG. 2. Embodiments can determine an average reflectivity over that band of reflectivity, as shown in Table 2. The controller can use each of those average reflectivity values as a contribution toward a color for the object that emitted those mmW energies. Table 4 shows how the average reflectivity for each frequency band is converted to a scaled hex value, which contributes to an overall color. At 440, the controller combines the plurality of color contributions to generate the display color. For example, Table 4 illustrates how the scaled two-digit hex values, for each of the three frequency bands, is concatenated together into a six-digit hexadecimal color. The scaled hex values are placed in order of increasing frequency, so that the scaled hex value from the band of lowest frequency occupies the leftmost position of the six-digit hexadecimal color value, and so on for middle frequency band and scaled hex value occupying the middle digits, and high frequency band and scaled hex value occupying the rightmost digits of the color. At 450, the controller outputs, using the display, a visualization of the object depicted using the display color. For example, the controller can access a lookup table for color values using the six-digit hexadecimal color to find that the output color is a deep red (corresponding to human skin). The controller then colors the displayed visualization of the object using that deep red, corresponding to areas of the object that exhibited the reflectivity values that contributed to that deep red color. Flowchart 400 can make use of average reflectivity values. Embodiments can collect values of reflectivity and frequency for each of the plurality of frequency bands, determine an average reflectivity for each frequency band based on averaging the values of reflectivity collected for each frequency band, and use the average reflectivity for each frequency band when converting the plurality of reflected mmW energies to the respective corresponding plurality of color contributions.

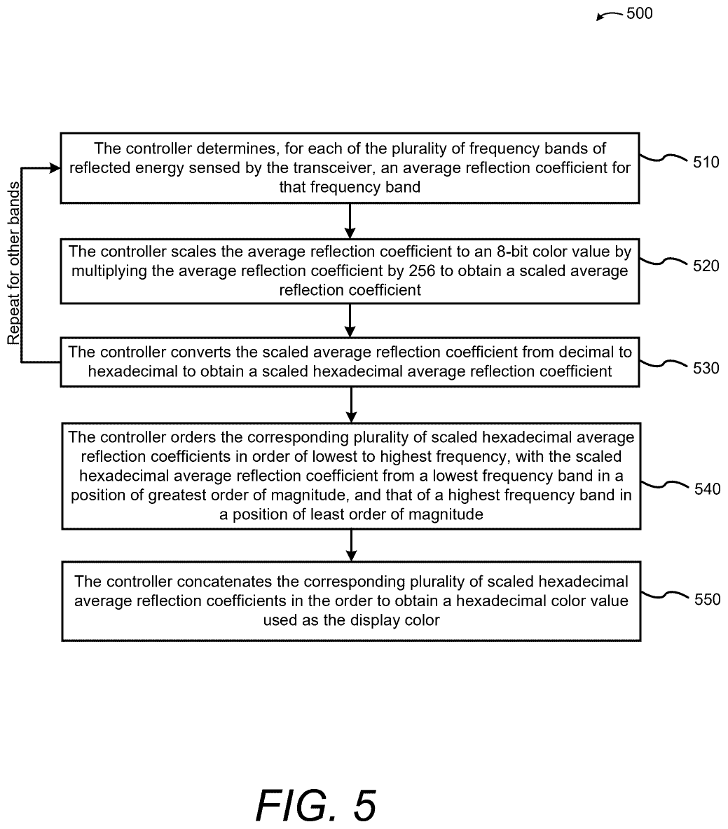

FIG. 5 illustrates a flowchart 500 to obtain a hexadecimal color value according to an embodiment. At 510, the controller determines, for each of the plurality of frequency bands of reflected energy sensed by the transceiver, an average reflection coefficient for that frequency band. For example, the controller can perform a summation according to equation (1) above, to sum values of reflectivity collected for that band of frequencies, and divide by the number of frequency samples. At 520, the controller scales the average reflection coefficient to an 8-bit color value by multiplying the average reflection coefficient by 256 to obtain a scaled average reflection coefficient. For example, the controller can multiply the value r̅ (e.g., as shown in table 4) by 256. For example, for skin 1, the value of r is 0.436. The controller can multiply that value by 256 to obtain the decimal 8-bit color scaled result for the average reflection coefficient 111.616. At 530, the controller converts the scaled average reflection coefficient from decimal to hexadecimal to obtain a scaled hexadecimal average reflection coefficient. For example, the controller converts the decimal value 111.616 to hexadecimal (rounding to two digits), which converts to 6F hexadecimal rounded off to two hex digits. The controller then repeats this approach for each of the frequency bands, obtaining scaled hexadecimal average reflection coefficients for each of the other frequency bands (represented by the back-pointing arrow in the flowchart 500 that points from block 530 back to block 510). After obtaining scaled hexadecimal average reflection coefficients for the plurality of frequency bands of reflected energy, flow proceeds to block 540. At 540, The controller orders the corresponding plurality of scaled hexadecimal average reflection coefficients in order of lowest to highest frequency, with the scaled hexadecimal average reflection coefficient from a lowest frequency band in a position of greatest order of magnitude, and that of a highest frequency band in a position of least order of magnitude. For example, table 4 illustrates the three two-digit scaled hex values 6F, 2F, and 29 listed in that order, corresponding to their frequency bands being arranged in order of increasing frequency. Accordingly, the scaled hex value from the lowest band (12-16 GHZ) occupies a position of highest magnitude in the hexadecimal color. Because the contribution of 6F corresponds to a red color, this causes the six-digit hexadecimal color to become mostly dark red. In other embodiments, different colors can be chosen to represent colors differently (e.g., using green to represent skin color). At 550, the controller concatenates the corresponding plurality of scaled hexadecimal average reflection coefficients in the order to obtain a hexadecimal color value used as the display color. For example, the controller concatenates 6F, 2F, and 29 in that order to form the hexadecimal color value 6F2F29. The controller can use a lookup table or other reference (e.g., an HTML color code lookup table) to pick the display color corresponding to the hexadecimal color value, and use that display color for the portions of the object that exhibited the measured mmW reflectivity characteristics. This approach is suitable for conductive materials that are more reflective in the lower frequency band than the higher frequency band. However, the high-to-low magnitude trend in frequency for conductive materials may not apply to embodiments for which dielectric relaxation affects the reflectivity. In some embodiments, the reflection coefficients are ordered differently than from lowest to highest frequency. The lowest frequency band does not necessarily correspond to a position of greatest order of magnitude, the highest frequency band does not necessarily correspond to a position of least order of magnitude, and the middle frequency band does not necessarily correspond to a position in between. Embodiments can use different mappings between frequency bands and positions of magnitude when concatenating.

While a number of embodiments of the present subject matter have been described, it should be appreciated that the present subject matter provides many applicable inventive concepts that can be embodied in a wide variety of ways. The embodiments discussed herein are merely illustrative of ways to make and use the subject matter and are not intended to limit the scope of the claimed subject matter. Rather, as will be appreciated by one of skill in the art, the teachings and disclosures herein can be combined or rearranged with other portions of this disclosure and the knowledge of one of ordinary skill in the art.

Terms and phrases used in this document, unless otherwise expressly stated, should be construed as open ended as opposed to closed-e.g., the term “including” should be read as meaning “including, without limitation” or the like; the term “example” is used to provide example instances of the item in discussion, not an exhaustive or limiting list thereof; the terms “a” or should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Furthermore, the presence of broadening words and phrases such as “one or more,” “at least,” “but not limited to,” or other similar phrases, should not be read to mean that the narrower case is intended or required in instances where such broadening phrases may be absent. Any headers used are for convenience and should not be taken as limiting or restricting. Additionally, where this document refers to technologies that would be apparent or known to one of ordinary skill in the art, such technologies encompass those apparent or known to the skilled artisan now or at any time in the future.

What is claimed is:

1. A system to visualize objects comprising:
at least one transceiver that emits millimeter wave (mmW) energy and senses reflected mmW energy at a plurality of frequency bands of mmW frequencies, as reflected by an object;
a display; and
a controller, coupled to the at least one transceiver and the display, that:
converts the plurality of reflected mmW energies, at the plurality of frequency bands of mmW frequencies, to a respective corresponding plurality of color contributions that contribute toward a display color;
combines the plurality of color contributions to generate the display color; and
outputs, using the display, a visualization of the object depicted using the display color.

2. The system of claim 1, wherein, for a given frequency band of mmW frequencies, the controller is configured to:
collect values of reflectivity and frequency for each of the plurality of frequency bands;
determine an average reflectivity for each frequency band based on averaging the values of reflectivity collected for each frequency band; and
use the average reflectivity for each frequency band when converting the plurality of reflected mmW energies to the respective corresponding plurality of color contributions.

3. The system of claim 1, wherein the plurality of frequency bands of mmW frequencies are non-contiguous.

4. The system of claim 1, wherein the plurality of frequency bands of mmW frequencies includes three frequency bands of 12-16 GHz; 21-25 GHz; and 30-34 GHz.

5. The system of claim 1, wherein the controller combines the contributions from the plurality of frequency bands by assigning the lowest frequency band as having the greatest magnitude contribution toward the display color, with higher frequency bands having correspondingly lesser magnitudes of contribution toward the display color.

6. The system of claim 1, wherein the plurality of color contributions is based on a color measure representing an intensity logarithm.

7. The system of claim 6, wherein the intensity logarithm is based on a logarithm of an average reflectivity for a first frequency band subtracted from a logarithm of an average reflectivity for a second frequency band.

8. The system of claim 1, wherein the controller is configured to perform a color lookup using a Hypertext Markup Language (HTML) color code lookup table to look up the combined plurality of color contributions to determine the display color corresponding to the combined plurality of color contributions.

9. The system of claim 1, wherein the plurality of color contributions is based on three contributions, from three frequency bands, translated to display color channels of red, blue, and green (RGB).

10. The system of claim 1, wherein the plurality of color contributions is based on four contributions, from four frequency bands, translated to display color channels of Cyan, Magenta, Yellow, and Black (CMYK).

11. The system of claim 1, further comprising a materials database including dielectric constant values for materials including human skin, wherein the controller is configured to implement a logistic regression statistic to identify whether the visualization of the object matches the human skin material of the materials database.

12. The system of claim 1, wherein the controller is configured to identify a generally uniform mmW color of a human object as human skin, and detect an anomaly based on a variation in the mmW color of the human object that deviates from the mmW color of the human skin by a detection threshold.

13. The system of claim 12, wherein the controller is configured to apply a privacy filter by subtracting the mmW color of the human skin to remove the human object from the display when displaying the anomaly.

14. The system of claim 1, wherein the controller is configured to:
determine, for each of the plurality of frequency bands of reflected energy sensed by the transceiver, an average reflection coefficient for that frequency band;
scale the average reflection coefficient to an 8-bit color value by multiplying the average reflection coefficient by 256 to obtain a scaled average reflection coefficient;
convert the scaled average reflection coefficient from decimal to hexadecimal to obtain a scaled hexadecimal average reflection coefficient; and
after obtaining scaled hexadecimal average reflection coefficients for the plurality of frequency bands of reflected energy, concatenate the corresponding plurality of scaled hexadecimal average reflection coefficients to obtain a hexadecimal color value used as the display color;
wherein the controller is configured to concatenate the corresponding plurality of scaled hexadecimal average reflection coefficients in order of lowest to highest frequency, with the scaled hexadecimal average reflection coefficient from a lowest frequency band in a position of greatest order of magnitude, and that of a highest frequency band in a position of least order of magnitude.

15. The system of claim 1, wherein the controller is configured to apply a transformation function to the plurality of color contributions to generate the display color based on combining a plurality of transformed color contributions.

16. A method to visualize objects, comprising:
emitting, by at least one transceiver, millimeter wave (mmW) energy;
sensing, by the at least one transceiver, reflected mmW energy at a plurality of frequency bands of mmW frequencies, as reflected by an object;
converting, by a controller coupled to the at least on transceiver and a display, the plurality of reflected mmW energies, at the plurality of frequency bands of mmW frequencies, to a respective corresponding plurality of color contributions that contribute toward a display color;
combining, by the controller, the plurality of color contributions to generate the display color; and
outputting, by the controller using the display, a visualization of the object depicted using the display color.

17. The method of claim 16, further comprising:
collecting values of reflectivity and frequency for each of the plurality of frequency bands;
determining an average reflectivity for each frequency band based on averaging the values of reflectivity collected for each frequency band; and
using the average reflectivity for each frequency band when converting the plurality of reflected mmW energies to the respective corresponding plurality of color contributions.

18. The method of claim 16, further comprising:
identifying, by the controller, a generally uniform mmW color of a human object as human skin; and
detecting an anomaly based on a variation in the mmW color of the human object that deviates from the mmW color of the human skin by a detection threshold.

19. The method of claim 18, further comprising applying, by the controller, a privacy filter by subtracting the mmW color of the human skin to remove the human object from the display when displaying the anomaly.

20. The method of claim 16, further comprising:
determining, by the controller for each of the plurality of frequency bands of reflected energy sensed by the transceiver, an average reflection coefficient for that frequency band;
scaling, by the controller, the average reflection coefficient to an 8-bit color value by multiplying the average reflection coefficient by 256 to obtain a scaled average reflection coefficient;
converting, by the controller, the scaled average reflection coefficient from decimal to hexadecimal to obtain a scaled hexadecimal average reflection coefficient; and
after obtaining scaled hexadecimal average reflection coefficients for the plurality of frequency bands of reflected energy, ordering, by the controller, the corresponding plurality of scaled hexadecimal average reflection coefficients in order of lowest to highest frequency, with the scaled hexadecimal average reflection coefficient from a lowest frequency band in a position of greatest order of magnitude, and that of a highest frequency band in a position of least order of magnitude; and
concatenating, by the controller, the corresponding plurality of scaled hexadecimal average reflection coefficients in the order to obtain a hexadecimal color value used as the display color.
